(19) United States
(12) Patent Application Publication
(10) Pub. No.: US 2026/0045244 A1
(43) Pub. Date: Feb. 12, 2026

(54) Calibration Method and Sound Producing Module

(71) Applicant: xMEMS Labs, Inc., Santa Clara, CA (US)

(72) Inventors: Jemm Yue Liang, Sunnyvale, CA (US); Hung-Chi Huang, Taoyuan City (TW)

(73) Assignee: xMEMS Labs, Inc., Santa Clara, CA (US)

(21) Appl. No.: 19/289,091

(22) Filed: Aug. 3, 2025

Related U.S. Application Data
(60) Provisional application No. 63/680,172, filed on Aug. 7, 2024.
(60) Provisional application No. 63/681,167, filed on Aug. 9, 2024.

(51) Int. Cl. G10K 9/02; G10K 9/12; G10K 9/18

(52) U.S. Cl. CPC G10K 9/02; G10K 9/12; G10K 9/18

(57) ABSTRACT

A calibration method comprises adjusting an operating frequency of an air-pulse generating device, such that a sound pressure level (SPL) of the air-pulse generating device is within a specific range. The sound producing module comprises the air-pulse generating device configured to produce sound via generating a plurality of air pulses at a pulse rate corresponding to the operating frequency.

### CROSS REFERENCE TO RELATED APPLICATIONS

This application claims the benefit of U.S. Provisional Application No. 63/681,167, filed on Aug. 9, 2024. Further, this application claims the benefit of U.S. Provisional Application No. 63/680,172, filed on Aug. 7, 2024. The contents of these applications are incorporated herein by reference.

### BACKGROUND OF THE INVENTION

### 1. Field of the Invention

The present application relates to a calibration method and a sound producing module, and more particularly, to a calibration method for sound producing modules capable of producing consistent acoustic performance.

### 2. Description of the Prior Art

Unless otherwise indicated herein, the approaches described in this section are not prior art to the claims in this application and are not admitted as prior art by inclusion in this section.

Air-pulse generating (APG) devices can be employed as sound producing devices or micro-speakers. APG devices may comprise film structure which is fabricated by MEMS (Micro-Electro-Mechanical Systems) fabrication process. However, manufacturing variations would cause APG devices producing various acoustic performances. For example, manufacturing variations may cause APG devices producing various sound pressure levels, even driving signals with the same driving amplitude are applied on the same type of APG devices

Therefore, it is necessary to improve the prior art.

### SUMMARY OF THE INVENTION

It is therefore a primary objective of the present application to provide a calibration method for sound producing modules capable of producing consistent acoustic performance against manufacturing variations, to improve over disadvantages of the prior art.

An embodiment of the present invention provides a calibration method configured to calibrate a sound producing module. The calibration method comprises adjusting an operating frequency of an air-pulse generating device, such that a sound pressure level (SPL) of the air-pulse generating device is within a specific range. The sound producing module comprises the air-pulse generating device configured to produce sound via generating a plurality of air pulses at a pulse rate corresponding to the operating frequency.

Another embodiment of the present invention discloses a sound producing module. The sound producing module comprises a memory, configured to store a calibrated operating frequency; and an air-pulse generating device, configured to produce a sound via generating a plurality of air pules at a pulse rate corresponding to the calibrated operating frequency. A second calibrated operating frequency is stored in a second memory within a second sound producing module distinct from the sound producing module. The calibrated operating frequency is different from the second calibrated operating frequency. A sound pressure level produced by the air-pulse generating device according to the calibrated operating frequency are consistent with a second sound pressure level produced by a second air-pulse generating device according to the second calibrated operating frequency which is different from the calibrated operating frequency. The second sound producing module comprises the second air-pulse generating device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an air-pulse generating (APG) device.

FIG. 2 illustrates waveforms of a demodulation driving signal and a modulation driving signal for the APG device of FIG. 1.

FIG. 3 illustrates a characteristic curve of conductance of virtual valve versus displacement difference and an AM demodulator for AM demodulation.

FIG. 4 illustrates an airflow I(t), an air pressure wave P(t) and a virtual valve conductance G(t).

FIG. 5 illustrates curves of displacement gain versus a ratio of Fr/Fv for the APG device of FIG. 1.

FIG. 6 illustrates SPL measurement results versus demodulation driving amplitude of the device of FIG. 1.

FIG. 7 is a schematic diagram of a calibration system according to an embodiment of the present application.

FIG. 8 illustrates a schematic diagram of a calibration process according to an embodiment of the present invention.

FIG. 9 illustrates a schematic diagram of a sound producing module according to an embodiment of the present invention.

FIG. 10 illustrates a schematic diagram of a calibration process according to an embodiment of the present invention.

### DETAILED DESCRIPTION

Content of U.S. Pat. Nos. 11,943,585, 12,261,567 and 12,107,546 is incorporated herein by reference.

By exploiting features of air-pulse generating (APG) device and its companion driving signal, it is possible to perform calibration via operating frequency.

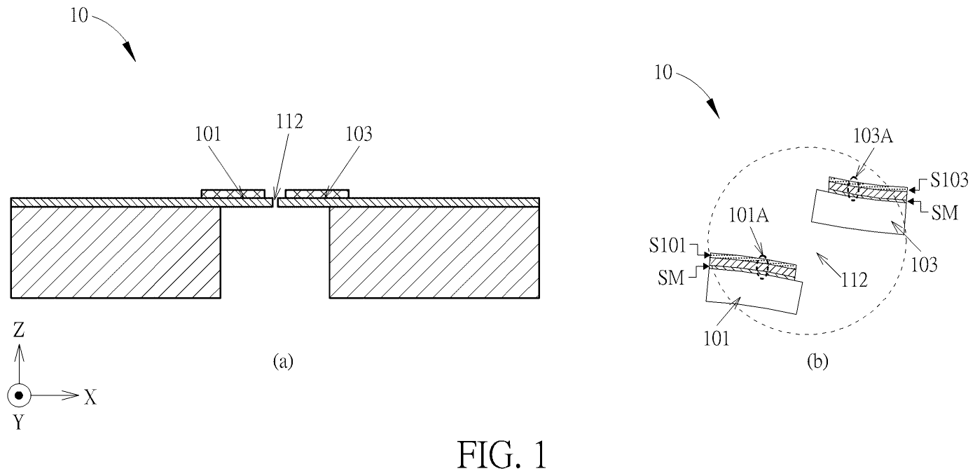

U.S. Pat. No. 11,943,585 filed by Applicant discloses an air-pulse generating (APG) device 10, which is shown in FIG. 1. The APG device 10 comprises a flap pair comprising flap 101 and 103. The APG device 10 also comprises an actuator 101A disposed on the flap 101 and an actuator 103A disposed on the flap 103. The actuator 101A/103A is driven by a demodulation driving signal S101/S103 and a modulation driving signal SM, to produce a plurality of air pulses at an ultrasonic pulse rate. The actuator 101A/103A comprises a top electrode and a bottom electrode. The two electrodes receive the demodulation driving signal and the modulation driving signal. In the embodiment shown in FIG. 1, the top electrode receives the demodulation driving signal S101/S103 and the bottom electrode receives the modulation driving signal SM, but not limited thereto.

The modulation driving signal SM drives the flap pair to perform a common mode movement. The demodulation driving signals S101 and S103 drive the flap pair to perform a differential mode movement. Suppose U_{z,101} and U_{z,103} represents displacement (in Z/vertical direction) of the flaps 101 and 103, respectively. Then the common mode movement may refer to a movement component of the flap pair which is (U_{z,101}+U_{z,103})/2, and the differential mode movement may refer to a movement component of the flap pair which is |U_{z,101}−U_{z,103}|/2.

A slit 112 is formed between the flaps 101 and 103. When the flap pair performs the differential mode movement (sometimes abbreviated as differential movement) such that ΔU_{z}=|U_{z,101}−U_{z,103}| is greater than a thickness of the flap, an opening (also denoted as 112) is formed. In one perspective, the differential movement of flaps 101 and 103 forms a virtual valve, also denoted as 112. When ΔU_{z} is small (smaller than the thickness of the flap) and/or an acoustic impedance/resistance is large so that airflow through the virtual valve 112 is negligible, the virtual valve 112 can be viewed as the slit 112, as shown in FIG. 1(a). When ΔU_{z} is large (larger than the thickness of the flap) and/or an acoustic impedance/resistance is small so that airflow through the virtual valve 112 is significant, the virtual valve 112 can be viewed as the opening 112, as shown in FIG. 1(b).

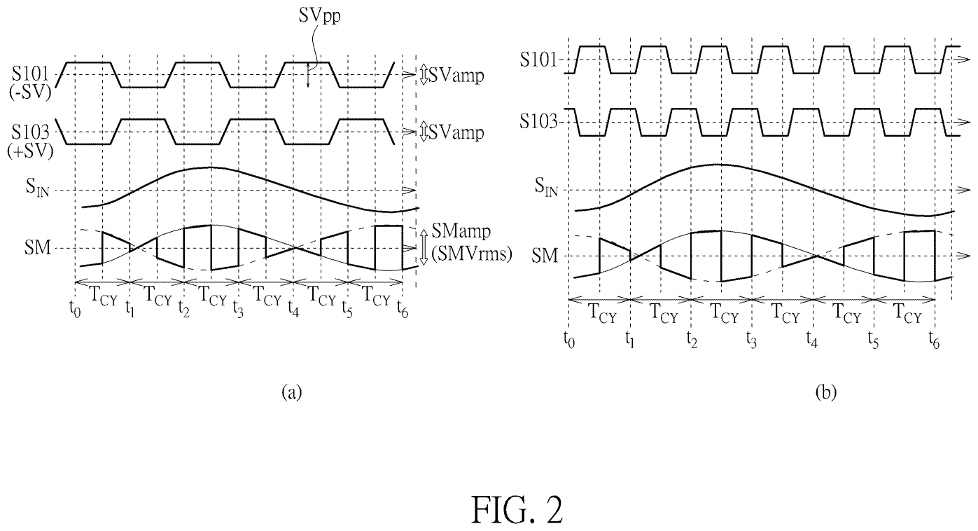

Waveforms of the demodulation driving signals S101, S103 and the modulation driving signal SM are shown in FIG. 2. The waveform of the modulation driving signal SM can be viewed as a (generalized) double sideband with suppressed carrier (DSB-SC), where a definition of “generalized DSB-SC” may be referred to U.S. Pat. No. 12,107,546 filed by Applicant, which is not narrated herein for brevity. The waveform of the demodulation driving signal S101/S103 can be viewed as a square/rectangular wave (similar to clock signal(s)), but not limited thereto. Note that, the phase relationship between the modulation driving signal and the demodulation driving signal is adaptable and not limited to the embodiment illustrated in FIG. 2.

The demodulation driving signals S101 and S103 may or may not be biased at the same level. When the demodulation driving signals S101 and S103 are biased at the same level, the flap pair may perform a symmetric differential movement without initial deflection. In this case, the demodulation driving signals S101 and S103 may be also denoted as +SV and −SV, as shown in FIG. 2(a). In the present application, notation “SV” is used to generally refer to the demodulation driving signal, which may represent either S101 or S103. On the other hand, when the demodulation driving signals S101 and S103 are biased at different levels, the flap pair would perform an asymmetric differential movement with asymmetric initial deflection. Herein, mechanical initial deflection of flap is corresponding to electrical voltage bias of/within the demodulation driving signals.

In an embodiment, as shown in FIG. 2(a), suppose the flap pair performs the symmetric differential movement without initial deflection, a demodulation frequency of the demodulation driving signals S101/S103 can be a half of a modulation frequency of the modulation driving signal SM. In another embodiment, as shown in FIG. 2(b), suppose the flap pair performs the asymmetric differential movement with asymmetric initial deflection (e.g., the flap 101 initially deflect toward a first direction (e.g., upward) and the flap 103 initially deflect toward a second direction opposite to the first direction (e.g., downward), which means the signal S101 may be biased at a voltage larger than the one of the signal S103), the demodulation frequency of the demodulation driving signals S101/S103 may be the same as the modulation frequency of the modulation driving signal SM.

In the present application, the demodulation frequency of the demodulation driving signals is also referred to (as) operating frequency of the APG device, denoted as fv. The ultrasonic pulse rate would be the modulation frequency of the modulation driving signal and corresponding to the operating frequency fv.

In the embodiment shown in FIG. 2(a), the virtual valve 112 is closed during the period corresponding to the demodulation driving signals S101, S103 being in transition. In the embodiment shown in FIG. 2(b), the virtual valve 112 is closed when one of the demodulation driving signals is high and the other is low. For example, in FIG. 2(b), the virtual valve 112 is closed when the signal S103 is high and the signal S101 is low, assuming the flap 101 initially deflects upward and the flap 103 initially deflects downward.

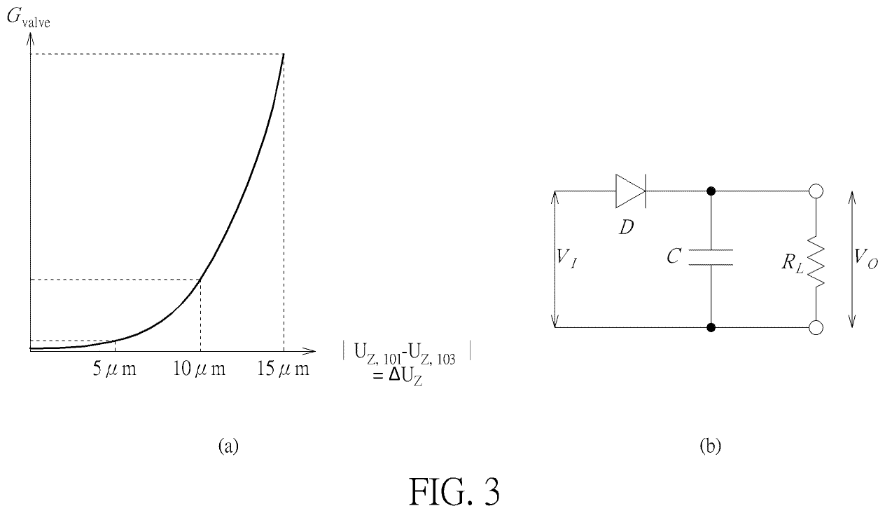

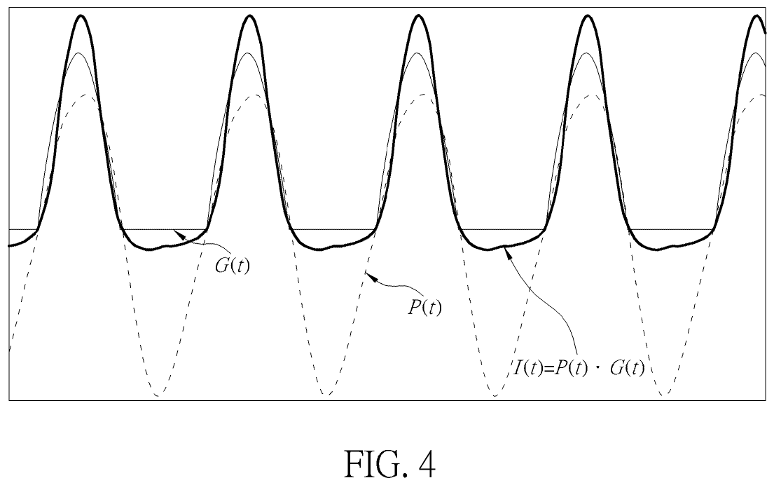

As taught by U.S. Pat. No. 11,943,585, in the modulation perspective, the modulation driving signal SM resulting in the common mode movement leads to generating amplitude-modulated (AM) wave (pressure variation). In the demodulation perspective, the virtual valve 112 controlled by the demodulation driving signal SV functions as an acoustic diode for AM demodulation, which is elaborated in FIG. 3 and FIG. 4.

FIG. 3 illustrates a (characteristic) curve of the conductance Gᵥₐₗᵥₑ of virtual valve 112 versus the displacement difference ΔU_{z} (in FIG. 3(a)) and an AM demodulator or an envelope detector for AM demodulation (in FIG. 3(b)). In FIG. 3(a), the characteristic curve is convex or concave up, and the valve conductance Gᵥₐₗᵥₑ increases faster as the displacement difference ΔU_{z} increases especially when ΔU_{z} is larger. The characteristic curve of the virtual valve 112 is similar to a characteristic of diode. The virtual valve 112 may be employed as an acoustic diode, e.g., in the context of AM demodulation. AM demodulation is known in the art. An analogy between the demodulation operation which the APG device performs and conventional known AM demodulator is described below. In FIG. 3(b), “V_{I}” may be analogous to the AM wave or AM pressure variation, “diode D” may be analogous to the virtual valve 112, “capacitor C” and “resistance R_{L}” represent acoustic capacitance and acoustic resistance of ambient and together form a low pass filer (LPF), and “V_{O}” may be analogous/corresponding to sound perceived by human ear.

In other words, given the common mode movement generates AM wave or AM pressure variation as “V_{I}”, the virtual valve 112 functions as diode “D” (as a rectifier) to produce unipolar air pulse, and acoustic capacitance “C” and resistance “R_{L}” embedded in ambient function as LPF to filter out ultrasonic component and leave audible portion (potion within audible spectrum band) “V_{O}” to human hearing system.

To see how the rectifier works, FIG. 4 illustrates an airflow I(t), produced by the APG device, which can be expressed as (or related to) an air pressure wave P(t) times a virtual valve conductance G(t), mathematically I(t)=P(t)·G(t) (eq. 1), demonstrating an effect of rectifier (brought by diode or virtual valve 112) in the AM demodulator or the envelope detector.

Note that, amplitude of output airflow I(t) would determine volume of sound which the APG device as sound producing device can produce. On the other hand, according to the concept behind FIG. 4 and eq. 1, amplitude of output airflow I(t) would be determined according to both amplitude of AM pressure wave P(t) (suppose P(t) is amplitude modulated) and amplitude of conductance G(t). The amplitude of AM pressure wave P(t) is affected by an amplitude of the modulation driving signal, denoted as SMamp. The amplitude of conductance G(t) is affected by the displacement difference ΔU_{z}, and the displacement difference ΔU_{z} is affected at least by an amplitude of the demodulation driving signal, denoted as SVamp.

Note that, SVamp generally represents demodulation driving amplitude, amplitude of the demodulation driving signal SV, sometimes abbreviated as demodulation amplitude. In an embodiment, the demodulation amplitude SVamp may be specifically a peak-to-peak voltage of the demodulation driving signal SV, denoted as SVpp, but not limited thereto. SMamp generally represents modulation driving amplitude, amplitude of the modulation driving signal SM, sometimes abbreviated as modulation amplitude. In an embodiment, the modulation amplitude SVamp may be a peak-to-peak voltage or a root-mean-square voltage of the modulation driving signal SM, but not limited thereto.

It can be concluded that, volume of the APG device as sound producing device would be affected by the displacement difference ΔU_{z} , and the displacement difference ΔU_{z} would be affected (at least) by the amplitude of the demodulation driving signal SVamp.

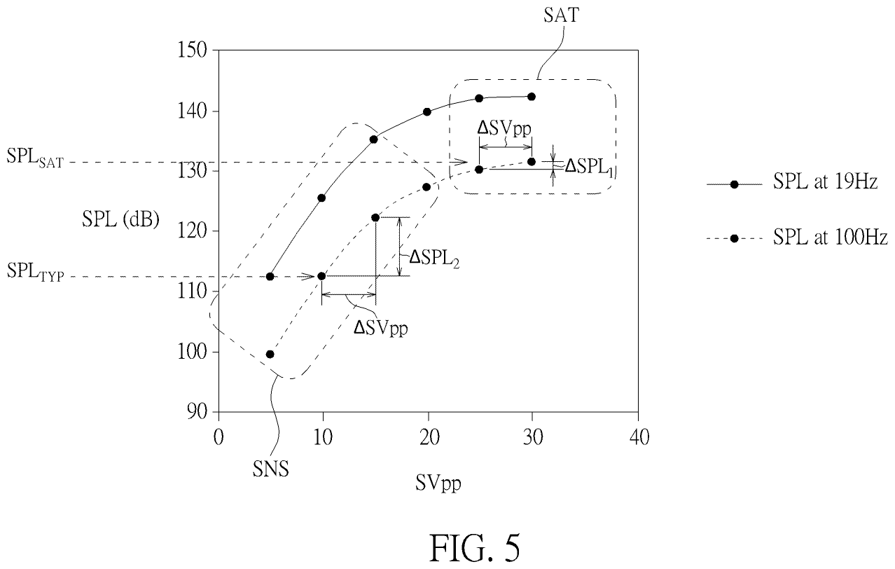

It can be validated by FIG. 5, excerpted from No. U.S. Pat. No. 11,943,585, where curves of volume (in terms of SPL (sound pressure level)) versus SVamp (in terms of SVpp), of the APG device as sound producing device, are illustrated. From FIG. 5, it can be observed that the volume increases as SVpp increases.

In addition to SVamp, the displacement difference ΔU_{z} would also be affected by the operating frequency fv. When the operating frequency fv approaches (or is closer to) a resonance frequency Fr of the air-pulse generating device, the flap 101/103 would have larger displacement and the flap pair has larger ΔU_{z} under the same amplitudes SVamp and SMamp applied on the actuators.

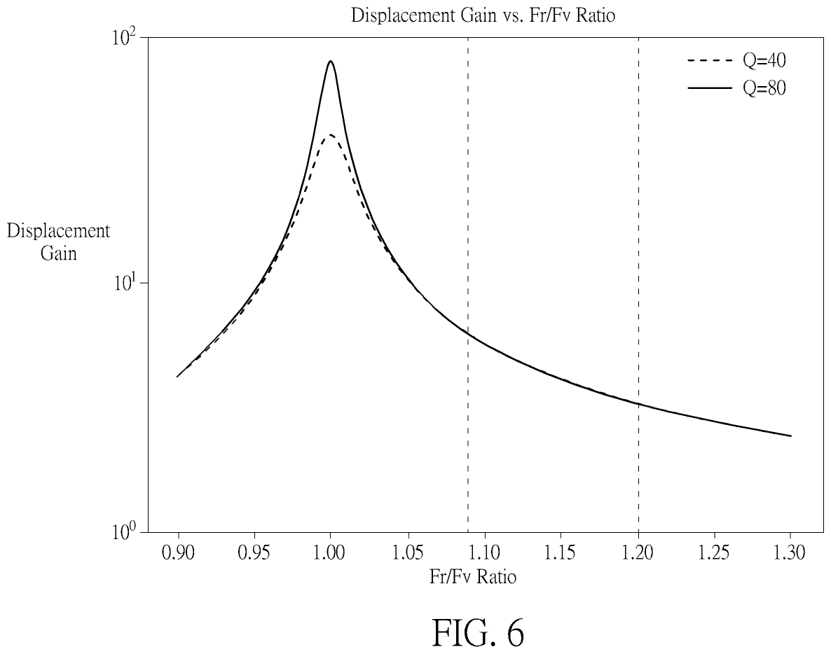

It can be validated by FIG. 6, illustrating curves of displacement gain (compared to DC (direct current) frequency being applied to the flap pair) versus a ratio of Fr/fv (for flap pair with different quality factor Q), where Fr/fv→1 means the operating frequency fv approaches a resonance frequency Fr, for the APG device 10.

It means that, in addition to the amplitude of the demodulation driving signal SVamp or SVpp, the operating frequency fv may also be a factor/parameter to adjust/affect the sound volume produced the APG device.

Note that, for mass production phase, volume produced by the APG device may be different from device to device, due to manufacturing variation. It means, even applying the same SVpp on a plurality of APG devices fabricated by the same manufacturing process, volume produced by the plurality of APG devices may be different from device to device.

Hence, a calibration process is needed to calibrate all the plurality of APG devices such that all the plurality of APG devices produces substantially the same volume.

Moreover, the APG device has its own companion driver. To promote commercial products of the APG devices, the APG device may be integrated with its corresponding driving circuit to be formed as a module, e.g., a sound producing module. In the production line, a plurality of APG devices may be integrated as a plurality of sound producing modules. The sound producing modules may be put on a testing/calibration apparatus to perform the calibration process.

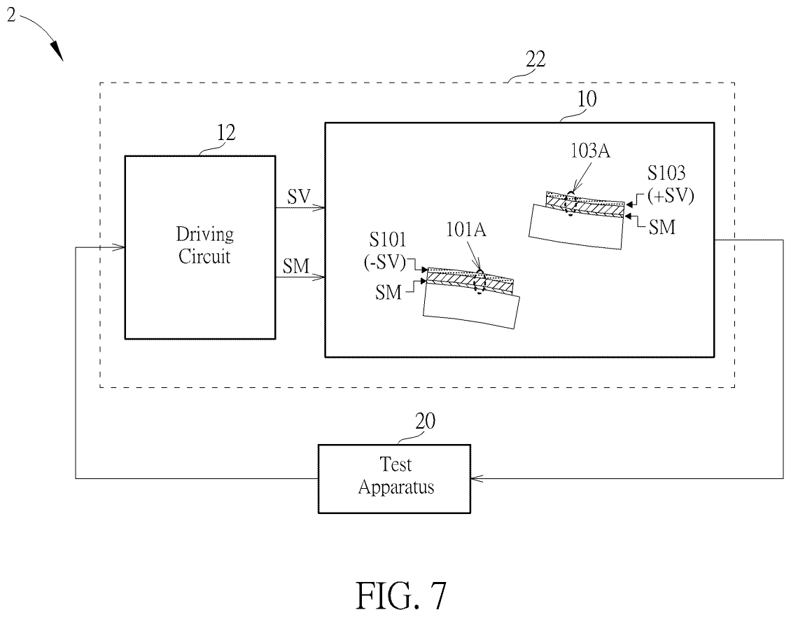

For example, FIG. 7 illustrates a schematic diagram of a calibration system 2 according to an embodiment of the present application. The calibration system 2 comprises a calibration apparatus 20. The calibration apparatus 20 may be a (testing) platform or a (testing) machine which may measure an acoustic or electric output of sound producing module(s) 22 and adjust parameter(s) for the sound producing module(s) 22 to produce the acoustic/electric output. In the embodiment shown in FIG. 7, the sound producing module 22 may comprise the APG device 10 and a driving circuit 12.

In an embodiment, the driving circuit 12 may comprise circuit disclosed in U.S. Pat. Nos. 12,261,567 and/or 12,107,546 filed by Applicant to produce the (de) modulation driving signals SV and SM, which is not limited thereto.

From the observation of FIG. 5 and FIG. 6, in an embodiment, the calibration process or the calibration system 2 may be configured to calibrate the operating frequency fv, so that the plurality of sound producing modules (which may, or may not, be from the same batch) produces substantially the same volume or consistent volume, or specifically, the SPL produced by the plurality of sound producing modules is within a specific range, e.g., within ±r % of SPL_{REF} (but not limited thereto), where r % may represent the tolerance of the products, and SPL_{REF} is the value specified on datasheet.

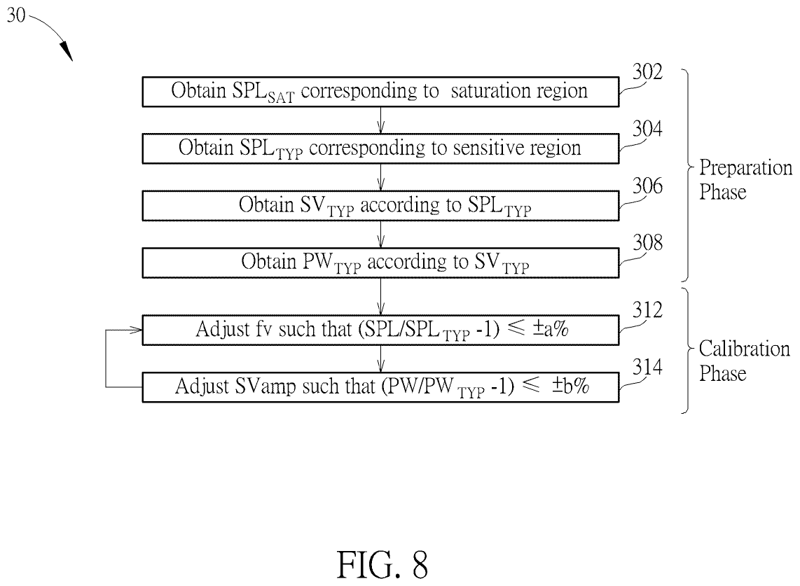

FIG. 8 illustrates a schematic diagram of a calibration process 30 according to an embodiment of the present invention. The calibration process 30 may be performed by the calibration system 2. The calibration process 30 comprises the following steps.

Step 302: Obtain a saturated sound pressure level SPL_{SAT} corresponding to a saturation region of the APG device.

Step 304: Obtain a typical sound pressure level SPL_{TYP} corresponding to a sensitive region of the APG device according to SPL_{SAT}.

Step 306: Obtain a typical driving amplitude SV_{TYP} according to SPL_{TYP}.

Step 308: Obtain a typical power PW_{TYP} according to SV_{TYP}.

Step 312: Adjust the operating frequency fv such that (SPL/SPL_{TYP}−1)≤±a %.

Step 314: Adjust SVamp such that (PW/PW_{TYP}−1)≤±b %.

Steps of the calibration process 30 can be divided into a preparation phase (comprising Steps 302, 304, 306, and 308) and a calibration phase (comprising Steps 312 and 314). In the preparation phase, the calibration apparatus 20 gathers statistics of a plurality of APG devices; while in the calibration phase, the calibration apparatus 20 uses those statistics to perform calibration on each APG device.

Specifically, in Step 302, the calibration apparatus 20 may obtain the saturated sound pressure level SPL_{SAT} corresponding to the saturation region of the APG device.

From FIG. 5, it can be observed that the APG device has a saturation region SAT and a sensitive region SNS. In the sensitive region SNS, the volume is sensitive to variation of demodulation driving amplitude SVamp/SVpp, under certain constant operating frequency fv and modulation driving amplitude SMamp. When the demodulation driving amplitude SVamp/SVpp is large, the APG device enters into the saturation region SAT such that a certain amount of increment/decrement on the driving amplitude SVamp/SVpp would not cause too much increment/decrement on SPL.

In other words, in the saturation region SAT, a first slope of the SPL vs. SVpp curve shown in FIG. 5 is less than a first value, e.g., ΔSPL₁ ΔSVpp<m₁. That is, in the saturation region SAT, a first increment/decrement of SPL (e.g., ΔSPL₁) caused by to an increment/decrement of demodulation driving amplitude (e.g., ΔSVpp) is less than a first threshold. On the other hand, in the sensitive region SNS, a second slope of the SPL vs. SVpp curve shown in FIG. 5 is greater than a second value, where the second value might be greater than the first value, e.g., ΔSPL₂ /ΔSVpp>m₂ where m₂>m₁. That is, in the sensitive region SNS, an increment/decrement of sound SP (e.g., ΔSPL₂) caused by to a second increment/decrement of demodulation driving amplitude (e.g., ΔSVpp) is greater than a second threshold, where the second threshold might be greater than the first threshold.

Suppose there are M APG devices to be calibrated. In an embodiment, the demodulation driving amplitude SVamp/SVpp of each APG device (among the M APG devices) may be increased to achieve its maximum SPL (making sure that the APG device operates within the saturation region SAT), and a plurality of first SPLs SPL_{MAX,1}, . . . , SPL_{MAX,M} are obtained. The saturated sound pressure level SPL_{SAT} may be obtained via taking a central statistic of the first SPLs SPL_{MAX,1}, . . . , SPL_{MAX,M}, where central statistic indicates center tendency of the plurality of first SPLs, which may be referred to mean/average, median or mode of the plurality of first SPLs. For example, SPL_{SAT}=mean (SPL_{MAX,1}, . . . , SPL_{MAX,M}), where mean(·) represents a mean function and returns a mean of input arguments.

In Step 304, the calibration apparatus 20 may obtain the typical sound pressure level SPL_{TYP} corresponding to the sensitive region SNS of the APG device according to SPL_{SAT}, where SPL_{TYP} is an SPL when the APG device in the sensitive region SNS can produce. In an embodiment, the calibration apparatus 20 may reduce SPL_{SAT} by a certain amount to obtain the typical sound pressure level SPL_{TYP}. For example, the calibration apparatus 20 may obtain SPL_{TYP} as SPL_{TYP}=SPL_{SAT}−20 dB (which is not limited thereto), to make sure that SPL_{TYP} corresponds to the sensitive region SNS.

In Step 306, the calibration apparatus 20 may find/lower the demodulation driving amplitude SVamp for each of the APG device (among the M APG devices) such that each APG device produces sound volume as SPL_{TYP}, and the corresponding demodulation driving amplitudes are SVamp₁, . . . , SVamp_{M}. In other words, the calibration apparatus 20 may obtain SVamp₁, . . . , SVamp_{M} such that the m-th APG device (among the M APG devices) produces sound volume as SPL_{TYP}. Further, the calibration apparatus 20 may take a central statistic of SVamp₁, . . . , SVamp_{M}, to obtain the typical driving amplitude SV_{TYP}. For example, the calibration apparatus 20 may obtain the typical driving amplitude SV_{TYP} as SV_{TYP}=mean (SVamp₁, . . . , SVamp_{M}) (but not limited thereto).

In Step 308, once the calibration apparatus 20 obtains the typical driving amplitude SV_{TYP}, the calibration apparatus 20 may obtain the typical power PW_{TYP} accordingly. For example, the calibration apparatus 20 may apply the typical driving amplitude SV_{TYP} on the M APG devices, measure their power PW₁, . . . ,PW_{M} and take a central statistic of PW₁, . . . ,PW_{M} to obtain the typical power PW_{TYP}, which is not limited thereto.

Note that, the preparation phase is configured to obtain statistics such as SPL_{TYP}, SV_{TYP} and PW_{TYP} from the M APG devices; while the in the calibration phase, SPL_{TYP}, SV_{TYP} and PW_{TYP} is used for calibration on each of the APG device.

Moreover, in preparation phase, the modulation amplitude SMamp and the operating frequency fv are kept constant, and the only parameter to adjust is the demodulation amplitude SVamp.

In Step 312, the calibration apparatus 20 adjusts the operating frequency fv of each APG device (e.g., a m-th APG device) such that the SPL of the each/m-th APG device satisfies (SPL/SPL_{TYP}−1)≤±a % (eq. 1), where a % represents tolerance (range). In an embodiment, a % may be set as 5% or 3.5% (but not limited thereto), depending on practical requirement(s).

Note that, in step 312, the calibration apparatus 20 adjusts the operating frequency fv while keeping the modulation amplitude SMamp and the demodulation amplitude SVamp constant. Moreover, the calibration apparatus 20 may remain the demodulation amplitude SVamp as constant as SV_{TYP}, which is obtained from the preparation phase.

In Step 314, the calibration apparatus 20 may slightly adjust the demodulation amplitude SVamp on each APG device (e.g., the m-th APG device) such that such that a power PW of the each/m-th APG device satisfies (PW/PW_{TYP}−1)≤±b % (eq. 2), where b % represents tolerance (range). In an embodiment, b % may be set as 7% (but not limited thereto), depending on practical requirement(s). In an embodiment, the calibration apparatus 20 may adjust the demodulation amplitude SVamp by one step at a time, with each step being a finest increment the apparatus 20 can achieve.

Note that, in step 314, the calibration apparatus 20 adjusts the demodulation amplitude SVamp while keeping the modulation amplitude SMamp and the operating frequency fv constant. Moreover, the calibration apparatus 20 may treat SV_{TYP} as an initial value for adjusting the demodulation amplitude SVamp.

In the embodiment shown in FIG. 8, Step 312 and Step 314 may be iteratively performed, until both conditions expressed in eq. 1 and eq. 2 are met.

After the calibration process 30 is done or the iteration within the calibration process 30 converges, the calibration apparatus 20 may obtain a calibrated operating frequency f_{V,cal,m} corresponding to the m-th APG device. The calibration apparatus 20 may store (the value of) the calibrated operating frequency f_{V,cal,m} in a memory within the sound producing module comprising the m-th APG device.

When the calibration (e.g., the calibration process 30 or 30′, where process 30′ will be introduced later) is performed on the M APG devices, the M APG devices may have different calibrated operating frequencies, but generate (substantially) the same SPL. It means that, when the calibration is performed on the M APG devices, the SPLs produced by the M APG devices are within specific tolerance range, under the small driving amplitude SVamp and SMamp.

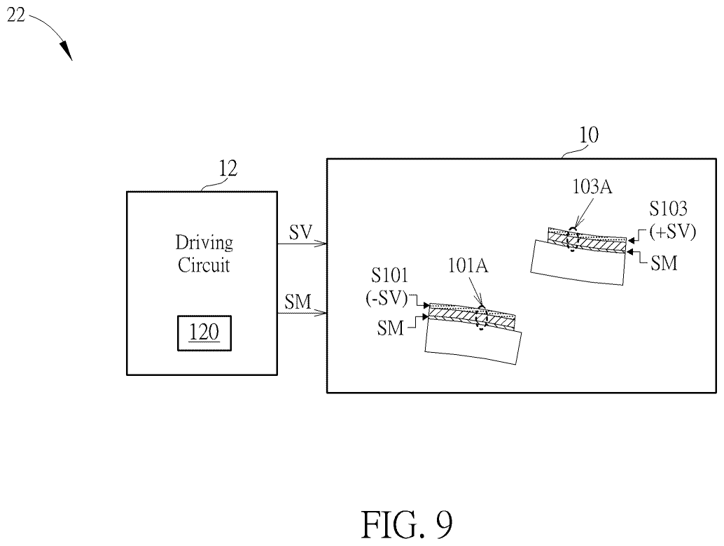

Referring to FIG. 9, in which the sound producing module 22 is reproduced. In FIG. 9, the driving circuit 12 comprises a memory 120. The memory 120 is configured to store a calibrated operating frequency f_{V,cal}. The driving circuit 12 may generate the demodulation and modulation driving signals SV and SM according to the calibrated operating frequency f_{V,cal}.

In an embodiment, the driving circuit 12 may comprise circuit disclosed in U.S. Pat. Nos. 12,261,567 and/or 12,107,546 filed by Applicant to produce the signals SV and SM, which is not limited thereto.

In other words, calibrated operating frequencies f_{V,cal,m}, f_{V,cal,m′} might be different for distinct APG devices or sound producing modules, and the sound producing levels SPLₘ and SPL_{m′} (of the m-th and the m′-th APG devices or sound producing modules) might be the same after performing the calibration (e.g., the calibration process 30 or 30′), under the condition of driving amplitude being consistent.

In the present application, sound producing levels or powers being consistent refers to being within tolerance range. For example, if both SPLₘ and SPL_{m′} satisfy eq. 1 (by substituting SPL_{m/m′} for SPL in eq. 1) or within ±r % of SPLREF, SPLₘ and SPL_{m′} are considered as consistent.

Notably, the embodiments stated in the above are utilized for illustrating the concept of the present application. Those skilled in the art may make modifications and alterations accordingly, and not limited herein. For example, power adjustment/calibration may be omitted under a circumstance that power consumption is less concern.

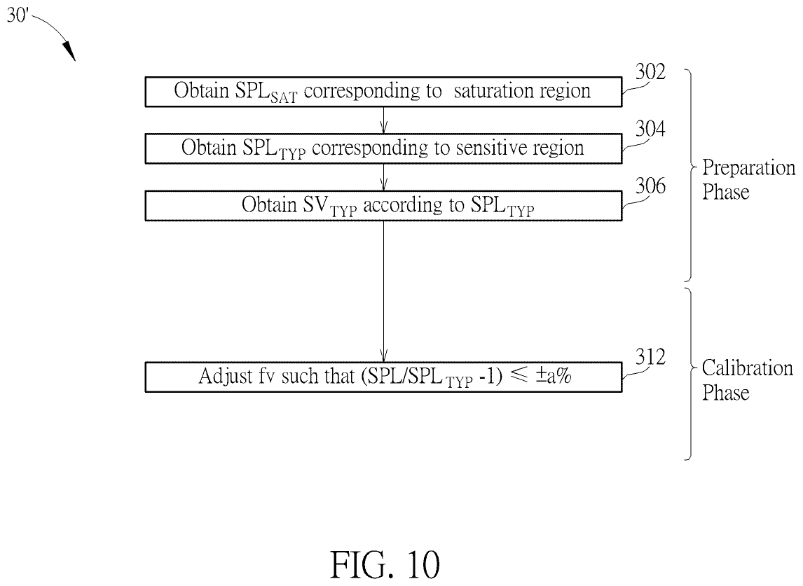

In this case, FIG. 10 illustrates a schematic diagram of a calibration process 30′ according to an embodiment of the present invention. The calibration process 30′, which may be performed by the calibration system 2, is similar to the calibration process 30. Different from the calibration process 30, power related Step 308 and Step 314 are omitted. Compared to the process 30, the calibration process 30′ concentrates on adjust the operating frequency fv to achieve consistent SPL, which may be adopted in the final testing (FT) procedure for mass production of the sound producing module with the APG devices.

In summary, the present invention exploits operating frequency with respect to resonance frequency to adjust displacement (difference) and therefore to adjust volume of APG devices. Operating frequency is adopted as an adjusting parameter for calibration. After performing the calibration, the APG devices or sound producing modules would produce consistent SPLs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration method, configured to calibrate a sound producing module, the calibration method comprising:
adjusting an operating frequency of an air-pulse generating device, such that a sound pressure level (SPL) of the air-pulse generating device is within a specific range;
wherein the sound producing module comprises the air-pulse generating device configured to produce sound via generating a plurality of air pulses at a pulse rate corresponding to the operating frequency.

2. The calibration method of claim 1, wherein the step of adjusting the operating frequency of the air-pulse generating device comprises:
obtaining a saturated sound pressure level corresponding to a saturation region of the air-pulse generating device;
obtaining a typical sound pressure level and corresponding to a sensitive region of the air-pulse generating according to the saturated sound pressure level;
obtaining a typical driving amplitude according to the typical sound pressure level; and
adjusting the operating frequency of a first air-pulse generating device, such that a first sound pressure level produced by the first air-pulse generating device is within a first specific range;
wherein in the saturation region a first increment of sound pressure level corresponding to an increment of driving amplitude is less than a first threshold;
wherein in the sensitive region a second increment of sound pressure level corresponding to the increment of driving amplitude is greater than a second threshold.

3. The calibration method of claim 2, wherein the step of obtaining the saturated sound pressure level corresponding to the saturation region of the air-pulse generating device comprises:
driving a plurality of air-pulse generating devices toward the saturation region;
obtaining a plurality of second sound pressure levels corresponding to the plurality of air-pulse generating devices operating within the saturation region; and
obtaining the saturated sound pressure level according to the plurality of second sound pressure levels.

4. The calibration method of claim 3, wherein the step of obtaining the saturated sound pressure level according to the plurality of first sound pressure levels comprises:
obtaining the saturated sound pressure level as a central statistic of the plurality of second sound pressure levels.

5. The calibration method of claim 3, wherein the step of driving the plurality of air-pulse generating devices toward the saturation region comprises:
adjusting a demodulation driving amplitude for the plurality of air-pulse generating devices toward the saturation region while keeping a modulation driving amplitude and the pulse rate constant.

6. The calibration method of claim 2, wherein the step of obtaining the typical SPL and the typical driving amplitude according to the saturated sound pressure level comprises:
obtaining the typical SPL as the saturated sound pressure level minus a certain amount; and
obtaining the typical driving amplitude corresponding to the typical SPL.

7. The calibration method of claim 6, wherein the step of obtaining the typical driving amplitude corresponding to the typical SPL comprises:
obtaining a plurality of driving amplitudes for a plurality of air-pulse generating devices such that the plurality of air-pulse generating devices produces sounds at the typical SPL; and
obtaining the typical driving amplitude as a central statistic of the plurality of driving amplitudes.

8. The calibration method of claim 2, wherein the step of adjusting the operating frequency comprises:
adjusting the operating frequency while keeping a demodulation driving amplitude and a modulation driving amplitude constant.

9. The calibration method of claim 2, wherein the step of adjusting the operating frequency comprises:
adjusting the operating frequency while keeping a demodulation driving amplitude as the typical driving amplitude.

10. The calibration method of claim 2, further comprising:
obtaining a typical power corresponding to the typical driving amplitude.

11. The calibration method of claim 2, further comprising:
adjusting a driving amplitude for the air-pulse generating device such that a power of the air-pulse generating device is within a second specific range.

12. The calibration method of claim 2, further comprising:
obtaining a calibrated operating frequency; and
storing the calibrated operating frequency in a memory within the sound producing module.

13. A sound producing module, comprising:
a memory, configured to store a calibrated operating frequency; and
an air-pulse generating device, configured to produce a sound via generating a plurality of air pules at a pulse rate corresponding to the calibrated operating frequency;
wherein a second calibrated operating frequency is stored in a second memory within a second sound producing module distinct from the sound producing module;
wherein the calibrated operating frequency is different from the second calibrated operating frequency;
wherein a sound pressure level produced by the air-pulse generating device according to the calibrated operating frequency are consistent with a second sound pressure level produced by a second air-pulse generating device according to the second calibrated operating frequency which is different from the calibrated operating frequency;
wherein the second sound producing module comprises the second air-pulse generating device.

14. The sound producing module of claim 13,
wherein the calibrated operating frequency and the second calibrated operating frequency are obtained via a calibration process.

15. The sound producing module of claim 13, comprising:
a driving circuit, comprising the memory, configured to generate a demodulation driving signal and a modulation driving signal according to the calibrated operating frequency.

16. The sound producing module of claim 15, wherein the air-pulse generating device comprises:
a flap; and
an actuator, disposed on the flap, comprising a first electrode and a second electrode;
wherein the first electrode and the second electrode receive the demodulation driving signal and the modulation driving signal;
wherein the demodulation driving signal and the modulation driving signal are generated according to the calibrated operating frequency.

17. The sound producing module of claim 15, wherein the air-pulse generating device comprises:
a flap pair, comprising a first flap and a second flap;
wherein the flap pair is driven by the demodulation driving signal to perform a differential mode movement and driven by the modulation driving signal to perform a common mode movement.

18. The sound producing module of claim 15,
wherein a volume of the sound produced by the air-pulse generating device is affected by a demodulation driving amplitude of the demodulation driving signal.

19. The sound producing module of claim 15,
wherein a volume of the sound produced by the air-pulse generating device is affected by a modulation driving amplitude of the modulation driving signal.

20. The sound producing module of claim 15,
wherein a volume of the sound produced by the air-pulse generating device is affected by an operating frequency corresponding to the demodulation driving signal and the modulation driving signal.
